(19) United States
(12) Patent Application Publication
(10) Pub. No.: US 2026/0070402 A1
(43) Pub. Date: Mar. 12, 2026

(54) VEHICLE FRAME MEMBER

(71) Applicant: Toyota Jidosha Kabushiki Kaisha, Toyota-shi (JP)

(72) Inventor: Daiki SHIMADA, Toyota-shi (JP)

(73) Assignee: Toyota Jidosha Kabushiki Kaisha, Toyota-shi (JP)

(21) Appl. No.: 19/234,786

(22) Filed: Jun. 11, 2025

(30) Foreign Application Priority Data
Sep. 12, 2024 (JP) 2024-158578

(51) Int. Cl. B60K 1/04; B60L 50/60; B62D 25/02; H01M 50/249

(52) U.S. Cl. CPC B60K 1/04; B62D 25/025; H01M 50/249; B60K 2001/0438; B60L 50/66; H01M 2220/20

(57) ABSTRACT

A vehicle frame member includes: an outer component extending in a vehicle width direction, joined to an upper surface of a battery case, and having a hat-shaped cross-section that is open on the lower side in a vehicle up-down direction as viewed from the vehicle width direction; and an inner component provided between the battery case and the outer component and forming, together with the outer component, a closed cross-section. The inner component includes a vertical wall extending in the vehicle up-down direction and a frame-shaped portion having a frame shape as viewed from the vehicle width direction.

### CROSS-REFERENCE TO RELATED APPLICATION

This application claims priority to Japanese Patent Application No. 2024-158578 filed on Sep. 12, 2024. The disclosure of the above-identified application, including the specification, drawings, and claims, is incorporated by reference herein in its entirety.

### BACKGROUND

### 1. Technical Field

The present disclosure relates to vehicle frame members.

### 2. Description of Related Art

Japanese Unexamined Patent Application Publication No. 2020-199897 (JP 2020-199897 A) discloses a vehicle structure in which floor cross members are welded to the upper surface of a floor. In the vehicle structure described in JP 2020-199897 A, a battery is mounted on the floor cross members via brackets.

### SUMMARY

In recent years, a structure is known that uses the upper surface of a battery case as a floor panel. In a structure that does not use a floor panel, floor cross members need to have a capacity to bear both a load that is applied in the vehicle width direction and a load that is applied in the vehicle up-down direction in the event of a side collision of a vehicle. However, increasing the cross section of the floor cross members makes it difficult to secure a large vehicle cabin space. Therefore, there is room for improvement in maintaining the load-bearing capacity of vehicle frame members such as floor cross members while reducing an increase in size thereof.

An object of the present disclosure is to provide a vehicle frame member that can maintain its load-bearing capacity while reducing an increase in size thereof.

A vehicle frame member of claim 1 includes:
an outer component extending in a vehicle width direction, joined to an upper surface of a battery case, and having a hat-shaped cross-section that is open on the lower side in a vehicle up-down direction as viewed from the vehicle width direction; and
an inner component provided between the battery case and the outer component and making up, together with the outer component, a closed cross-section.
   The inner component includes a vertical wall extending in the vehicle up-down direction and a frame-shaped portion having a frame shape as viewed from the vehicle width direction.

The vehicle frame member of claim 1 includes the outer component and the inner component. The outer component has a hat-shaped cross-section that is open on the lower side in the vehicle up-down direction as viewed from the vehicle width direction. The outer component extends in the vehicle width direction and is joined to the upper surface of the battery case. The inner component is provided between the battery case and the outer component and forms, together with the outer component, a closed cross-section. Since the outer component and the battery case form a closed cross-section and the outer component and the inner component form a closed cross-section inside this closed cross-section, the rigidity of the vehicle frame member can be improved without increasing the size of the vehicle frame member.

The inner component includes the vertical wall extending in the vehicle up-down direction and the frame-shaped portion having a rectangular frame shape as viewed from the vehicle width direction. Providing the vertical wall as described above improves the capacity to bear a load applied in the vehicle up-down direction.

According to the vehicle frame member of claim 2, in claim 1, a fastening portion to which a cover covering an electronic device is fastened is provided in an upper part of the outer component at such a position that the fastening portion overlaps the vertical wall as viewed in plan.

In the vehicle frame member of claim 2, the fastening portion for the cover is provided at such a position that the fastening portion overlaps the vertical wall as viewed in plan. Therefore, a load applied from the cover to the vehicle frame member can be effectively received by the vertical wall.

According to the vehicle frame member of claim 3, in claim 2, the frame-shaped portion is fixed to an upper end of the outer component.

In the vehicle frame member of claim 3, the frame-shaped portion improves the rigidity of the upper end of the outer component. The frame-shaped portion has a frame shape. Therefore, even when a bolt, a nut, etc. are placed in the fastening portion, the bolt, the nut, etc. will not interfere with the frame-shaped portion.

According to the vehicle frame member of claim 4, in claim 1, the inner component includes
a front flange extending in a vehicle front-rear direction along the battery case,
a front vertical wall component extending upward from a rear end of the front flange,
a rear flange located rearward of the front flange and extending in the vehicle front-rear direction along the battery case,
a rear vertical wall component extending upward from a front end of the rear flange and joined to the front vertical wall component, and
the frame-shaped portion connecting an upper end of the front vertical wall component and an upper end of the rear vertical wall component.

In the vehicle frame member of claim 4, the inner component includes the front flange, the front vertical wall component, the rear flange, the rear vertical wall component, and the frame-shaped portion. Therefore, the inner component can be easily formed by pressing a steel plate. The vertical wall is formed by joining the front vertical wall component and the rear vertical wall component. This improves the load-bearing capacity compared to the case where the vertical wall is formed by a single steel plate.

According to the vehicle frame member of claim 5, in claim 4, the frame-shaped portion includes a front bottom extending forward from the upper end of the front vertical wall component and a rear bottom extending rearward from the upper end of the rear vertical wall component, and
the front bottom and the rear bottom are provided at such positions that the front bottom and the rear bottom overlap a partition as viewed from the vehicle width direction. The partition divides the inside of a rocker into upper and lower parts. The rocker is provided on both sides in the vehicle width direction and extends in the vehicle front-rear direction.

In the vehicle frame member of claim 5, the frame-shaped portion includes the front bottom and the rear bottom. The front bottom and the rear bottom are provided at such positions that the front bottom and the rear bottom overlap the partition as viewed from the vehicle width direction. The partition divides the inside of the rocker into upper and lower parts. This allows part of a load applied to the rocker in the event of a side collision to be substantially linearly transferred from the partition to the front bottom and the rear bottom. As a result, the impact load can be effectively transferred.

As described above, the vehicle frame member of the present disclosure can maintain its load-bearing capacity while reducing an increase in size thereof.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a side sectional view showing a main part of a vehicle including a floor cross member according to an embodiment;

FIG. 2 is a schematic perspective view of the floor cross member according to the embodiment;

FIG. 3 is a side sectional view of the floor cross member according to the embodiment; and

FIG. 4 is a front view schematically showing a main part of the vehicle according to the embodiment.

### DETAILED DESCRIPTION OF EMBODIMENTS

A floor cross member 10 that is a vehicle frame member according to an embodiment will be described with reference to the drawings.

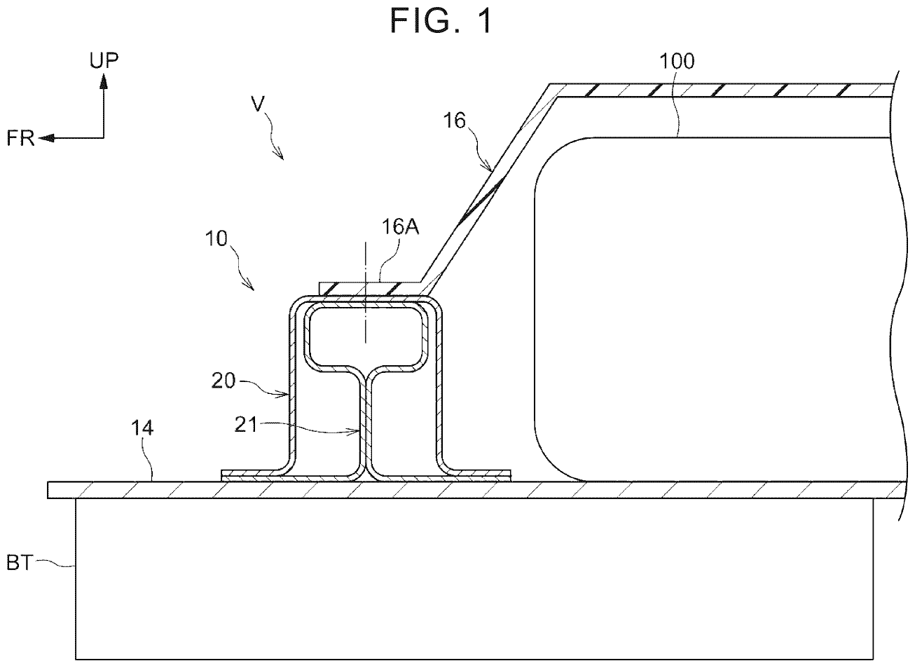

FIG. 1 is a side sectional view showing a main part of a vehicle V including a floor cross member 10 according to an embodiment. The arrow FR, the arrow UP, and the arrow LH in the drawings indicate the vehicle forward direction, the vehicle upper direction, and the vehicle left direction in the vehicle V, respectively. When terms indicating directions, i.e., forward and rearward, upward and downward, and right and left, are used in the following description, these terms means forward and rearward in the vehicle front-rear direction, upward and downward in the vehicle up-down direction, and right and left in the vehicle left-right direction (width direction) unless otherwise specified.

As shown in FIG. 1, the vehicle V of the present embodiment includes a battery BT. The battery BT is disposed in a lower part of the vehicle V, and is housed in a battery case 12. The battery BT is used as a secondary battery that can store electric power to be supplied to a drive motor, not shown.

The vehicle V can be widely applied to vehicles that use electric power as at least part of a drive source such as a hybrid electric vehicle (HV) and a plug-in hybrid electric vehicle (PHEV) in addition to a battery electric vehicle (BEV) that uses only a motor as a drive source.

The battery case 12 is made of, for example, a metal, and includes an upper case 14 that covers the battery BT from above. The floor cross member 10 is provided on the upper surface of the upper case 14. The material of the battery case 12 is not particularly limited, and for example, the battery case 12 may be made of resin etc.

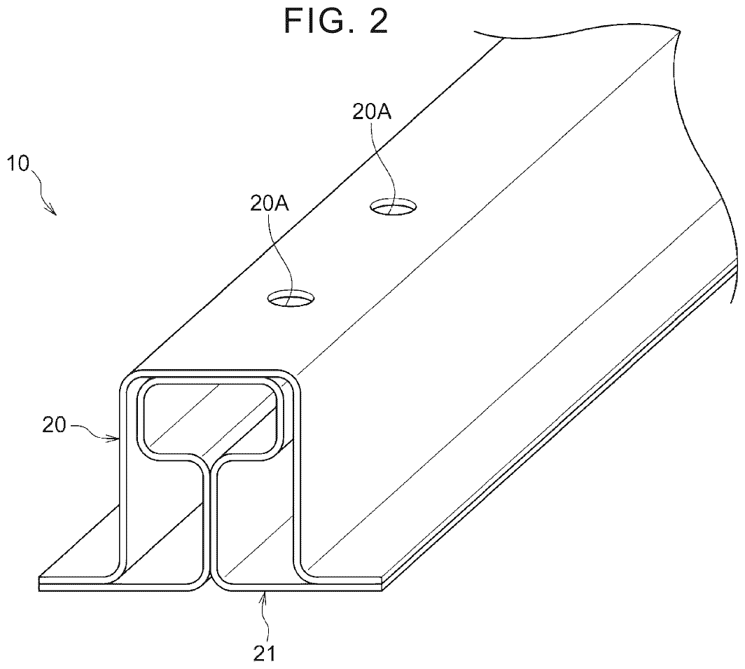

As shown in FIG. 2, the floor cross member 10 extends in the vehicle width direction. The floor cross member 10 includes an outer component 20 that forms the outer side, and an inner component 21 that is provided inside the outer component 20.

A fastening hole 20A that is a fastening portion is formed in the upper surface of the floor cross member 10. A plurality of fastening holes 20A is formed at intervals in the vehicle width direction. Although two fastening holes 20A are shown in FIG. 2, three or more fastening holes 20A may be formed.

As shown in FIG. 1, a cover 16 is fastened to an upper end of the floor cross member 10. The cover 16 is made of, for example, resin and covers an electronic device 100. Although the electronic device 100 covered by the cover 16 is not particularly limited, the electronic device 100 may be, for example, a converter such as an inverter and a converter. The electronic device 100 may be an auxiliary battery etc.

The cover 16 protrudes upward so as to conform to the shape of the electronic device 100, and a front end portion 16A of the cover 16 is fastened to the upper end of the floor cross member 10.

### Floor Cross Member 10

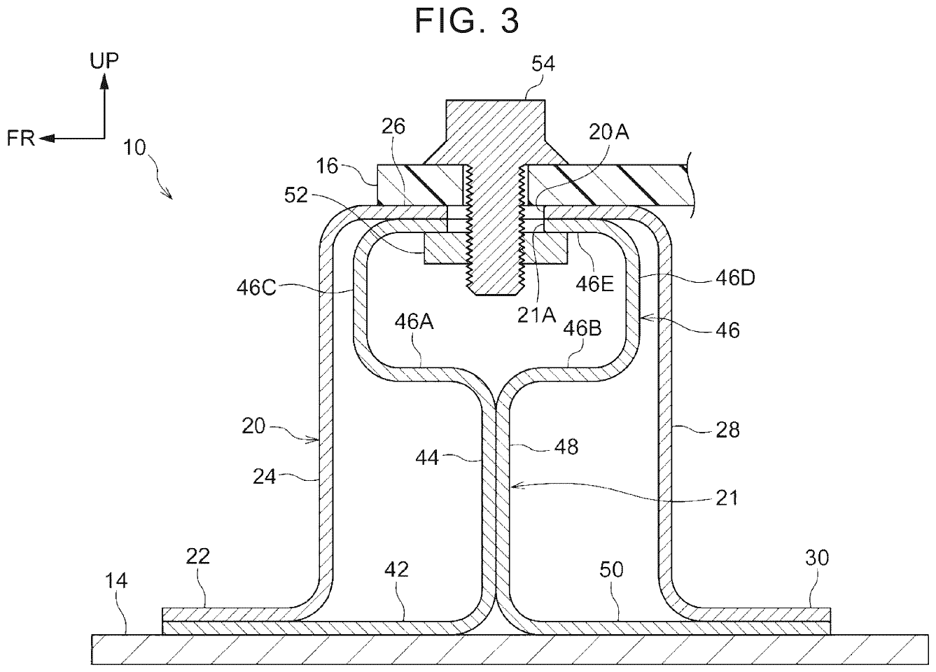

As shown in FIG. 3, the floor cross member 10 includes the outer component 20 and the inner component 21. The outer component 20 is a metal member joined to the upper surface of the battery case 12 and having a generally hat-shaped cross-section that is open on the lower side in the vehicle up-down direction as viewed from the vehicle width direction.

Specifically, the outer component 20 includes a front flange 22, a front wall 24, an upper wall 26, a rear wall 28, and a rear flange 30, and is formed by, for example, press working.

The front flange 22 extends in the vehicle front-rear direction along the battery case 12, and is joined, together with a front flange 42 of the inner component 21 described later, to the battery case 12. The front wall 24 extends in the vehicle up-down direction, and the lower end of the front wall 24 is connected to the rear end of the front flange 22. The upper end of the front wall 24 is connected to the front end of the upper wall 26.

The upper wall 26 extends in the vehicle front-rear direction, and the front end of the upper wall 26 is connected to the upper end of the front wall 24. The upper end of the rear wall 28 is connected to the rear end of the upper wall 26. The rear wall 28 extends in the vehicle up-down direction, and the upper end of the rear wall 28 is connected to the rear end of the upper wall 26. The lower end of the rear wall 28 is connected to the front end of the rear flange 30.

The rear flange 30 extends in the vehicle front-rear direction along the battery case 12, and is joined, together with a rear flange 50 of the inner component 21 described later, to the battery case 12. Since the front flange 22 and the rear flange 30 of the outer component 20 are joined to the battery case 12 as described above, the outer component 20 and the battery case 12 form a closed cross-section.

The inner component 21 is a metal member that is provided between the battery case 12 and the outer component 20 and forms, together with the outer component 20, a closed cross-section. Specifically, the inner component 21 includes the front flange 42, a front vertical wall component 44, the rear flange 50, a rear vertical wall component 48, and a frame-shaped portion 46.

The front flange 42 extends in the vehicle front-rear direction along the battery case 12, and is longer in the vehicle front-rear direction longer than the front flange 22 of the outer component 20. The front end portion of the front flange 42 is located under the lower surface of the front flange 22 of the outer component 20, and is joined, together with the front flange 22, to the battery case 12 by welding etc. The front flange 22 of the outer component 20 and the front flange 42 of the inner component 21 may be placed on top of each other and mechanically joined by fasteners such as bolts and rivets.

The front vertical wall component 44 extends upward from the rear end of the front flange 42. The front vertical wall component 44 is shorter in the vehicle up-down direction than the front wall 24 of the outer component 20. The upper end of the front vertical wall component 44 is connected to the frame-shaped portion 46.

The rear flange 50 extending in the vehicle front-rear direction along the battery case 12 is disposed rearward of the front flange 42. The rear flange 50 is longer than the rear flange 30 of the outer component 20, and has substantially the same length as the front flange 42. The rear end portion of the rear flange 50 is placed under the lower surface of the rear flange 30 of the outer component 20, and is joined, together with the rear flange 30, to the battery case 12 by welding etc. The rear flange 30 of the outer component 20 and the rear flange 50 of the inner component 21 may be placed on top of each other and mechanically joined by fasteners such as bolts and rivets.

The rear vertical wall component 48 extends upward from the front end of the rear flange 50. The rear vertical wall component 48 is shorter in the vehicle up-down direction than the rear wall 28 of the outer component 20. The upper end of the rear vertical wall component 48 is connected to the frame-shaped portion 46.

The front vertical wall component 44 and the rear vertical wall component 48 are placed on top of on each other in the vehicle front-rear direction, and are joined by welding etc. The front vertical wall component 44 and the rear vertical wall component 48 form a “vertical wall” of the present disclosure. That is, the vertical wall of the present disclosure includes two steel plates extending in the vehicle up-down direction.

The frame-shaped portion 46 has a frame shape and connects the upper end of the front vertical wall component 44 and the upper end of the rear vertical wall component 48. Specifically, the frame-shaped portion 46 has a generally rectangular frame shape as viewed from the vehicle width direction, and includes a front bottom 46A extending forward from the upper end of the front vertical wall component 44 and a rear bottom 46B extending rearward from the upper end of the rear vertical wall component 48.

The front bottom 46A extends substantially parallel to the front flange 42 in the vehicle front-rear direction, and the front end of the front bottom 46A is located near the front wall 24 of the outer component 20. An inner front wall 46C extends upward in the vehicle up-down direction from the front end of the front bottom 46A.

The inner front wall 46C extends in the vehicle up-down direction, and the lower end of the inner front wall 46C is connected to the front end of the front bottom 46A. The upper end of the inner front wall 46C abuts on the upper wall 26 of the outer component 20.

The rear bottom 46B extends substantially parallel to the rear flange 50 in the vehicle front-rear direction, and the rear end of the rear bottom 46B is located near the rear wall 28 of the outer component 20. An inner rear wall 46D extends upward in the vehicle up-down direction from the rear end of the rear bottom 46B.

The inner rear wall 46D extends in the vehicle up-down direction, and the lower end of the inner rear wall 46D is connected to the rear end of the rear bottom 46B. The upper end of the inner rear wall 46D abuts on the upper wall 26 of the outer component 20.

The upper end of the inner front wall 46C and the upper end of the inner rear wall 46D are connected to each other in the vehicle front-rear direction by an inner upper wall 46E. The inner upper wall 46E extends in the vehicle front-rear direction, and is placed on the lower surface of the upper wall 26 of the outer component 20 and joined to the upper wall 26. That is, the frame-shaped portion 46 is fixed to the upper end of the outer component 20.

Since the outer component 20 and the inner component 21 are formed as described above, three closed cross-sections are formed inside the outer component 20. Specifically, the front wall 24, the front flange 42, the front vertical wall component 44, the front bottom 46A, and the inner front wall 46C form a closed cross-section. The rear wall 28, the rear flange 50, the rear vertical wall component 48, the rear bottom 46B, and the inner rear wall 46D also form a closed cross-section. The frame-shaped portion 46 also forms a closed cross-section.

The fastening holes 20A are formed in the middle portion of the upper wall 26 of the outer component 20 in the vehicle front-rear direction. Communication holes 21A communicating with the fastening holes 20A are formed in the middle portion of the inner upper wall 46E of the inner component 21 in the vehicle front-rear direction. The communication holes 21A are formed at positions corresponding to the fastening holes 20A, and bolts 54 are inserted into the fastening holes 20A and the communication holes 21A.

The inner upper wall 46E of the inner component 21 is provided with weld nuts 52, and the cover 16 is fastened to the upper end of the floor cross member 10 by tightening the bolts 54 through the weld nuts 52 with the cover 16 interposed therebetween.

The fastening holes 20A that are the fastening portion to which the cover 16 is fastened is formed at such positions that they overlap the front vertical wall component 44 and the rear vertical wall component 48 as viewed in plan. In the present embodiment, as an example, the fastening holes 20A and the communication holes 21A have substantially the same size. However, the present disclosure is not limited to this, and the fastening holes and the communication holes may have different sizes. For example, a fixing margin of the weld nuts 52 may be secured by making the communication holes 21A smaller in diameter than the fastening holes 20A.

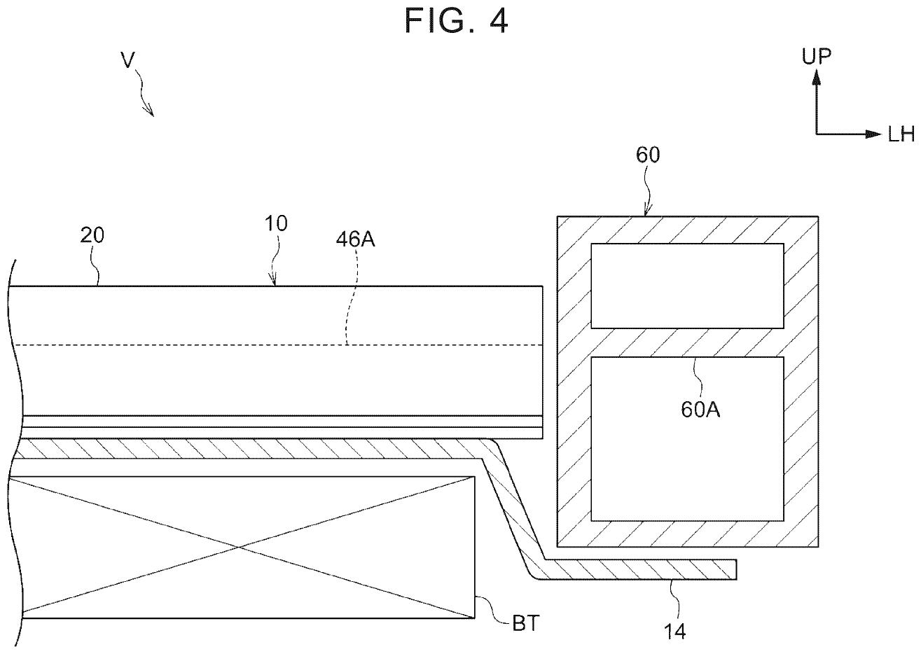

FIG. 4 is a front view schematically showing a main part of the vehicle V according to the embodiment. As shown in FIG. 4, rockers 60 that are frame members are provided on both sides of the vehicle V in the vehicle width direction. Although only the left rocker 60 is shown in FIG. 4, the same rocker 60 is provided on the right side.

The rocker 60 extends in the vehicle front-rear direction and has a closed cross-section structure having a generally rectangular cross section. In the present embodiment, as an example, the rocker 60 is formed by extrusion molding of metal. However, the present disclosure is not limited to this, and the rocker 60 may be formed by joining two steel plates.

An end of the battery case 12 in the vehicle width direction is disposed below the rocker 60, and the battery case 12 is fixed to the rocker 60 by fasteners such as bolts and nuts, not shown.

The rocker 60 is provided with a partition 60A that divides the inner space into upper and lower parts. The partition 60A is located slightly above the middle of the rocker 60 in the vehicle up-down direction and extends in the vehicle width direction. The right end of the partition 60A is joined to the right inner wall of the rocker 60, and the left end of the partition 60A is joined to the left inner wall of the rocker 60. In the present embodiment, the body of the rocker 60 and the partition 60A are integrally formed by extrusion molding.

The partition 60A is located at the same height as the front bottom 46A and the rear bottom 46B of the floor cross member 10. That is, the front bottom 46A and the rear bottom 46B are formed at such positions that they overlap the partition 60A as viewed from the vehicle width direction.

### Functions

Next, functions of the vehicle frame member according to the present embodiment will be described.

As shown in FIG. 3, the vehicle frame member according to the present embodiment includes the outer component 20 and the inner component 21, and the outer component 20 has a hat-shaped cross-section that is open on the lower side in the vehicle up-down direction as viewed from the vehicle width direction. The outer component 20 extends in the vehicle width direction and is joined to the upper surface of the battery case 12. The inner component 21 is provided between the battery case 12 and the outer component 20, and forms, together with the outer component 20, closed cross-sections. The outer component 20 and the battery case 12 form a closed cross-section, and the outer component 20 and the inner component 21 form closed cross-sections inside this closed cross-section. This improves rigidity without increasing the size of the floor cross member 10.

The inner component 21 includes a vertical wall (front vertical wall component 44, rear vertical wall component 48) extending in the vehicle up-down direction, and the frame-shaped portion 46 having a rectangular frame shape as viewed from the vehicle width direction. Providing the vertical wall in this manner improves the capacity to bear a load that is applied in the vehicle up-down direction. As described above, according to the present disclosure, it is possible to maintain the load-bearing capacity while reducing an increase in size of the floor cross member 10.

In the floor cross member 10 of the present embodiment, the fastening holes 20A that are the fastening portion of the cover 16 are provided at such positions that they overlap the front vertical wall component 44 and the rear vertical wall component 48 as viewed in plan. Therefore, a load applied from the cover 16 to the floor cross member 10 can be effectively received by the front vertical wall component 44 and the rear vertical wall component 48 that are the vertical wall. In particular, in the present embodiment, the vertical wall is formed by placing two steel plates, namely the front vertical wall component 44 and the rear vertical wall component 48, together. This improves the load-bearing capacity compared to the case where the vertical wall is formed by a single steel plate.

In the floor cross member 10 of the present embodiment, the rigidity of the upper end of the outer component 20 can be improved by the frame-shaped portion 46. As a result, for example, even in a structure in which the floor cross member 10 supports a vehicle seat, the floor cross member 10 can receive a load from the vehicle seat without increasing the size thereof.

The frame-shaped portion 46 has a frame shape. Therefore, the bolts 54 will not interfere with the frame-shaped portion 46 even when they are inserted through the fastening holes 20A and the communication holes 21A. That is, the distal ends of the bolts 54 and the weld nuts 52 can be disposed inside the closed cross-section of the frame-shaped portion 46.

Moreover, in the floor cross member 10 of the present embodiment, the inner component 21 includes the front flange 42, the front vertical wall component 44, the rear flange 50, the rear vertical wall component 48, and the frame-shaped portion 46. Therefore, the inner component 21 can be easily formed by pressing a steel plate.

Furthermore, as shown in FIG. 4, in the present embodiment, the frame-shaped portion 46 includes the front bottom 46A and the rear bottom 46B. The front bottom 46A and the rear bottom 46B are formed at such positions that they overlap the partition 60A that divides the inside of the rocker 60 into upper and lower parts, as viewed from the vehicle width direction. Accordingly, part of the load applied to the rocker 60 in the event of a side collision can be transferred substantially linearly from the partition 60A to the front bottom 46A and the rear bottom 46B. As a result, the impact load can be effectively transferred.

Although the floor cross member 10 according to the present disclosure is described above, it should be understood that the present disclosure can be implemented in various forms without departing from the gist of the present disclosure. For example, as shown in FIG. 3, in the above embodiment, the front vertical wall component 44 and the rear vertical wall component 48 of the inner component 21 are joined together. However, the present disclosure is not limited to this. In the above embodiment, the inner upper wall 46E of the frame-shaped portion 46 is joined to the upper wall 26. However, the present disclosure is not limited to this, and clearance may be provided between the frame-shaped portion 46 and the upper wall 26.

In the above embodiment, the inner component 21 may have other shapes as long as it includes a vertical wall and a frame-shaped portion. For example, the front vertical wall component 44 and the rear vertical wall component 48 may have a generally corrugated shape as viewed from the side. Alternatively, part of the front vertical wall component 44 may protrude toward the front of the vehicle. For example, the middle portion of the front vertical wall component 44 in the vehicle up-down direction may protrude toward the front of the vehicle and contact the front wall 24. This increases the number of closed cross-sections and ridgelines inside the outer component 20 and improves the load-bearing capacity. The same applies to the rear vertical wall component 48. However, providing a space between the front wall 24 and the front vertical wall component 44 as in the present embodiment allows additional weld nuts to be provided inside this space. This is preferable in that another member can be fastened to the front of the floor cross member 10. Similarly, providing a space between the rear wall 28 and the rear vertical wall component 48 allows additional weld nuts to be provided inside this space. This is preferable in that another member can be fastened to the rear of the floor cross member 10.

Regarding the above embodiment, the following appendices are disclosed.

### Appendix 1

A vehicle frame member includes: an outer component extending in the vehicle width direction, joined to the upper surface of a battery case, and having a hat-shaped cross-section that is open on the lower side in the vehicle up-down direction as viewed from the vehicle width direction; and
an inner component provided between the battery case and the outer component and forming, together with the outer component, a closed cross-section.
   The inner component includes a vertical wall extending in the vehicle up-down direction and a frame-shaped portion having a frame shape as viewed from the vehicle width direction.

### Appendix 2

In the vehicle frame member according to Appendix 1, a fastening portion to which a cover covering an electronic device is fastened is provided in an upper part of the outer component at such a position that the fastening portion overlaps the vertical wall as viewed in plan.

### Appendix 3

In the vehicle frame member according to Appendix 1 or 2, the frame-shaped portion is fixed to an upper end of the outer component.

### Appendix 4

In the vehicle frame member according to any one of Appendices 1 to 3, the inner component includes
a front flange extending in a vehicle front-rear direction along the battery case,
a front vertical wall component extending upward from a rear end of the front flange,
a rear flange located rearward of the front flange and extending in the vehicle front-rear direction along the battery case,
a rear vertical wall component extending upward from a front end of the rear flange and joined to the front vertical wall component, and
the frame-shaped portion connecting an upper end of the front vertical wall component and an upper end of the rear vertical wall component.

### Appendix 5

In the vehicle frame member according to Appendix 4, the frame-shaped portion includes a front bottom extending forward from the upper end of the front vertical wall component and a rear bottom extending rearward from the upper end of the rear vertical wall component, and
the front bottom and the rear bottom are provided at such positions that the front bottom and the rear bottom overlap a partition as viewed from the vehicle width direction, the partition dividing inside of a rocker into upper and lower parts, and the rocker being provided on both sides in the vehicle width direction and extending in the vehicle front-rear direction.

What is claimed is:

1. A vehicle frame member comprising:
an outer component extending in a vehicle width direction, joined to an upper surface of a battery case, and having a hat-shaped cross-section that is open on a lower side in a vehicle up-down direction as viewed from the vehicle width direction; and
an inner component provided between the battery case and the outer component and making up, together with the outer component, a closed cross-section,
wherein the inner component includes a vertical wall extending in the vehicle up-down direction and a frame-shaped portion having a frame shape as viewed from the vehicle width direction.

2. The vehicle frame member according to claim 1, wherein a fastening portion to which a cover covering an electronic device is fastened is provided in an upper part of the outer component at such a position that the fastening portion overlaps the vertical wall as viewed in plan.

3. The vehicle frame member according to claim 2, wherein the frame-shaped portion is fixed to an upper end of the outer component.

4. The vehicle frame member according to claim 1, wherein the inner component includes
a front flange extending in a vehicle front-rear direction along the battery case,
a front vertical wall component extending upward from a rear end of the front flange,
a rear flange located rearward of the front flange and extending in the vehicle front-rear direction along the battery case,
a rear vertical wall component extending upward from a front end of the rear flange and joined to the front vertical wall component, and
the frame-shaped portion connecting an upper end of the front vertical wall component and an upper end of the rear vertical wall component.

5. The vehicle frame member according to claim 4, wherein:
the frame-shaped portion includes a front bottom extending forward from the upper end of the front vertical wall component and a rear bottom extending rearward from the upper end of the rear vertical wall component; and
the front bottom and the rear bottom are provided at such positions that the front bottom and the rear bottom overlap a partition as viewed from the vehicle width direction, the partition dividing inside of a rocker into upper and lower parts, and the rocker being provided on both sides in the vehicle width direction and extending in the vehicle front-rear direction.
